(19) United States
(12) Patent Application Publication
(10) Pub. No.: US 2010/0259226 A1
(43) Pub. Date: Oct. 14, 2010

(54) BATTERY MANAGING DEVICE AND THE METHOD OF USING THE SAME

(76) Inventors: Linwang Deng, Shenzhen (CN); Xuejian Wu, Shenzhen (CN); Jianhua Zhang, Shenzhen (CN)

Correspondence Address: BRINKS HOFER GILSON & LIONE, P.O. BOX 10395, CHICAGO, IL, 60610, US

(21) Appl. No.: 12/688,317

(22) Filed: Jan. 15, 2010

(30) Foreign Application Priority Data
Jan. 16, 2009 (CN) 200910105109.0

(51) Int. Cl. H02J 7/04

(52) U.S. Cl. 320/150; 320/162

(57) ABSTRACT

A battery managing device includes a charger operatively coupled to a battery, and a single chip configured to determine a charging voltage and a charging current of the battery, which correlate to a residual capacitance of the battery. The single chip is configured to control the charger to charge the battery in accordance with the determined charging voltage and charging current. A method of managing battery charging using a single chip and a charger coupled to a battery includes (1) using a single chip to determine a charging voltage and a charging current of the battery, which correlate to a residual capacitance of the battery, and (2) controlling the charger to charge the battery in accordance with the determined charging voltage and charging current.

### CROSS-REFERENCE TO RELATED APPLICATIONS

This application claims priority to and benefit of Chinese Patent Application Serial No. 200910105109.0, filed on Jan. 16, 2009.

### BACKGROUND OF THE INVENTION

1. Field of the Invention

The present invention relates to a battery managing device and a method of using the battery managing device.

2. Background of the Related Art

With the advancement of the society and the development of the economy, people pay more attention to the hybrid power vehicles and electric vehicles for they can save the energy and reduce the emission of carbon dioxide. But charging a battery of such vehicles is difficult because of the huge capacitance of the battery. There is much work to do to improve the technique of charging. The disadvantage of the present charger is that the charging controlling curve does not aim at the battery. The charging controlling curve which is saved in advance in the charger is not correlative to the battery.

### SUMMARY OF THE INVENTION

The present invention provides a battery managing device which correlates the charger to the battery charging characteristics.

The present invention provides a battery managing device including a single chip used for determining a charging voltage and a charging current correlative to a residual capacitance of the battery and controlling the charger coupled to the battery managing device to charge the battery in the charging voltage and charging current determined by the single chip.

The present invention further provides a method of using the battery managing device, including (1) determining a charging voltage and a charging current correlative to a residual capacitance of the battery via the single chip; (2) controlling the charger coupled to the battery managing device to charge the battery in the charging voltage and charging current via the single chip.

The battery managing device according to the present invention determines a charging voltage and a charging current correlative to a residual capacitance of the battery and controls the charger coupled to the battery managing device to charge the battery in the determined charging voltage and charging current. It makes the charger be more correlative to the battery.

### BRIEF DESCRIPTION OF THE DRAWINGS

The aforementioned features and advantages of the invention as well as additional features and advantages thereof will be more clearly understood hereinafter as a result of a detailed description of embodiments when taken in conjunction with the drawings.

FIG. 1 is the graph illustrating the relationship of known chargers between the charging parameters and the time. The charging parameters include the amount of the capacitance which has been run out or drained, the charging voltage and the charging current.

FIG. 2 shows the connection relationship among the charger, the battery managing device and the battery.

FIG. 3 shows an embodiment of the battery managing device.

### DETAILED DESCRIPTION

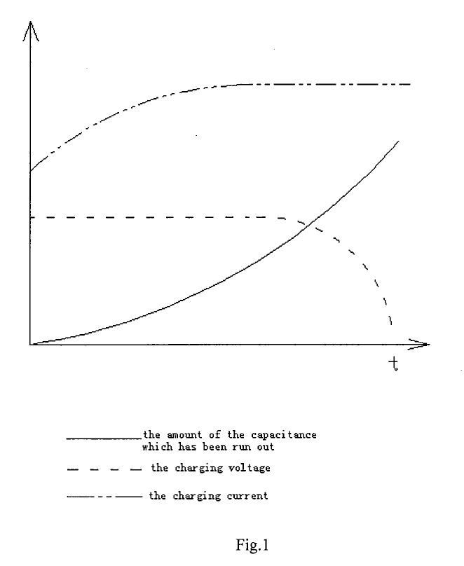

FIG. 1 shows the relationship of the prior charger between the charging parameters and the time. The charging parameters include the amount of the capacitance which has been run out, the charging voltage and the charging current. The relationship curve is obtained by experiment. The technicians can draw the appropriate relationship curve among the residual capacitance, the charging voltage and the charging current. The battery is discharged completely. Then the battery is charged in different groups of the charging voltage and charging current correlative to the battery character curve to draw the relationship curve among the residual capacitance, the charging voltage and the charging current. Then the appropriate relationship curve among the residual capacitance, the charging voltage and the charging current is built up by experiment. When the residual capacitance is detected, the battery can be charged in the charging voltage and charging current according to the relationship curve. The relationship curve is corresponding to the character of the battery. The character information of the battery can be stored in the memorizer module. The character information of the battery can be obtained before the battery is charged.

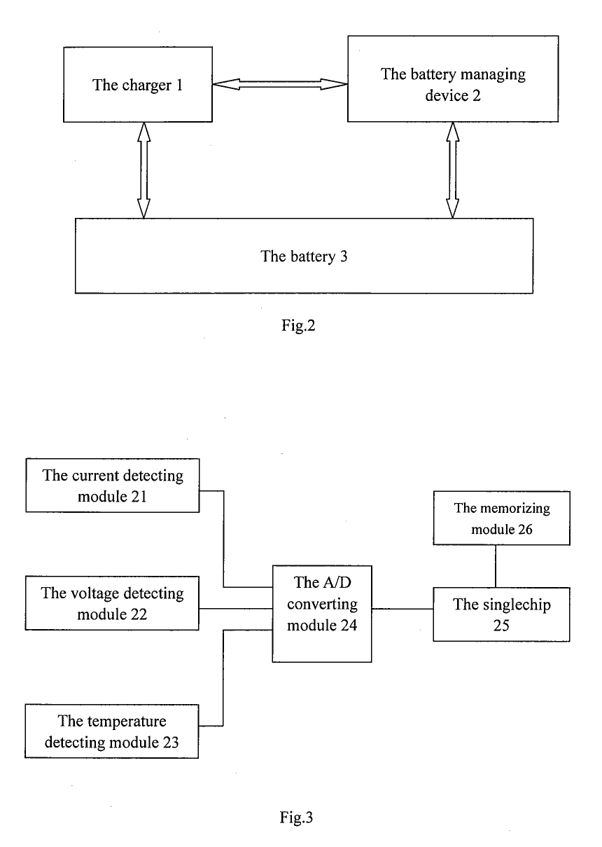

As shown in FIG. 2, the battery managing device 2 includes a single chip 25 used for determining a charging voltage and a charging current correlative to a residual capacitance of the battery 3 and controlling the charger 1 coupled to the battery managing device 2 to charge the battery 3 in the determined charging voltage and charging current.

The charger 1 is an ordinary charger known by the technicians. The charger 1 includes an AC/DC voltage converting module or DC/DC voltage converting module used for converting the voltage of the power grid into the voltage needed by the battery, a hardware protecting circuit used for protecting the hardware and the charging receiver.

The present invention further provides a method of using the battery managing device 2 including a single chip 25, including: (1) determining a charging voltage and a charging current correlative to a residual capacitance of the battery via the single chip; (2) controlling the charger coupled to the battery managing device to charge the battery in the charging voltage and charging current via the single chip.

The battery managing device further includes a capacitance detecting module (not shown in figures) and an A/D converting module (not shown in figures). The capacitance detecting module is coupled to the A/D converting module. The A/D converting module is coupled to the single chip 25. The capacitance detecting module is used for detecting the residual capacitance of the battery 3. The capacitance detecting module is known by the technicians.

The charger works in the high voltage and current. The detecting information may be influenced by the electromagnetic interference which is generated by the charger. It is difficult to detect the battery information. In order to overcome the difficulty, the battery managing device according to an embodiment of the present invention includes a current detecting module 21, a voltage detecting module 22, a temperature detecting module 23, an A/D converting module 24, a single chip 25 and a memorizer module 26. The current detecting module 21, the voltage detecting module 22 and the temperature detecting module 23 is respectively coupled to the A/D converting module 24. The A/D converting module 24 is coupled to the single chip 25. The memorizer module 26 is coupled to the single chip 25.

The battery 3 includes a battery monomer or more. As a preferred embodiment, the battery 3 includes several series-wound battery monomers.

The series-wound battery monomers can be divided into several battery groups. The battery groups can have the same number of the battery monomers. Or the battery groups can have the different numbers of the battery monomers. As a preferred embodiment, the battery groups can have the same number of the battery monomers. The temperature detecting module 23 detects the temperature of each battery monomer and battery group.

The current detecting module 21 is used for detecting the current of the battery 3 when the battery 3 is discharged. The voltage detecting module 22 is used for detecting the voltage of the battery monomer when the battery 3 is charged.

The current detecting module 21, the voltage detecting module 22 and the temperature detecting module 23 is respectively coupled to the A/D converting module 24. The A/D converting module 24 is used for converting the current detected by the current detecting module 21, the voltage detected by the voltage detecting module 22 and the temperature detected by the temperature detecting module 23 into digital information and delivering the digital information to the single chip 25.

The memorizer module 26 is used for storing the information of the total capacitance of the battery 3, the residual capacitance of the battery 3, the rated voltage of the battery monomer and the rated voltage of the battery 3. The memorizer module 26 is further used for recording the information when the battery 3 is discharged or charged, such as the current, the time of being discharged or charged. The memorizer module 26 also record how many times the battery 3 has been charged. The information can be used in the research and development of the battery.

The battery managing device 2 can be coupled to the charger 1 in many kinds of ways. As a preferred embodiment of the invention, both the battery managing device 2 and the charger 1 have a CAN communicating module. The charger 1 further has a single chip. The battery managing device 2 is coupled to the charger 1 via a CAN bus so that they can communicate conveniently. The battery managing device 2 can be coupled to the charger 1 in other ways as long as the information of the charging voltage and charging current generated by the battery managing device 2 can be sent to the charger 1. And then the charger can charge the battery according to the information of the charging voltage and charging current.

As a preferred embodiment of the invention, the step (1) includes (1-1) obtaining an original residual capacitance of the battery from the memorizing module and determining an original charging voltage and an original charging current correlative to the original residual capacitance via the single chip; (1-2) determining a present charging voltage and a present charging current correlative to the present residual capacitance of the battery via the single chip.

The original residual capacitance in step (1-1) is calculated by following steps: (1-1-1) obtaining the amount of the capacitance which has been run out via the single chip, wherein the amount of the capacitance which has been run out (drained) is the integral value of the discharging voltage and the discharging current calculated by the single chip; (1-1-2) subtracting the amount of the capacitance which has been run out (drained) from the total capacitance of the battery to obtain the original residual capacitance via the single chip; (1-1-3) storing the original residual capacitance in the memorizer module via the single chip; (1-1-4) obtaining the original residual capacitance from the memorizer module via the single chip when the battery is charged.

In step (1-1-1), the battery managing device 2 is coupled to the battery 3. For example, the battery managing device 2 can be integrated with the battery 3 to record the information of the battery 3.

The present residual capacitance in step (1-2) is calculated by following steps: (1-2-1) obtaining the amount of the capacitance which has been stored in the battery when the battery is charged via the single chip; (1-2-2) obtaining the present residual capacitance by adding the original residual capacitance and the amount of the capacitance which has been stored in the battery when the battery is charged via the single chip; wherein the amount of electricity which has been stored in the battery is the integral value of the charging voltage and the charging current.

Further, the method includes: (3) determining whether the battery 3 is fully charged by the single chip 25. The single chip 25 determines whether the residual capacitance of the battery 3 is as much as the total capacitance or whether the voltage of one of the battery monomers is as much as the rated voltage to determine whether the battery 3 is fully charged. As a preferred embodiment, the single chip 25 determines whether the voltage of one of the battery monomers is as much as the rated voltage to determine whether the battery 3 is fully charged. It can prolong the life-span of the battery 3.

The step (3) includes: (3-1) controlling the charger 1 to stop charging the battery 3 via the single chip when the battery 3 is fully charged; (3-2) controlling the charger 1 to continue charging the battery 2 via the single chip when the battery 1 is not fully charged.

In order to protect the battery monomer of the battery 3, the battery managing device further includes a temperature detecting module coupled to the A/D converting module, the step (1) and step (2) further includes: (s-1) dividing the series-wound battery monomers into several battery groups and detecting the temperature of every battery monomer and battery group via the temperature detecting module 23; (s-2) determining whether the temperature of one of the battery monomers and battery groups reaches the predetermined safe temperature via the temperature detecting module 23; (s-3) alarming and stopping charging the battery 3 if the temperature of one of the battery monomers and battery groups reaches the predetermined safe temperature; (s-4) going on charging the battery 3 if the temperature of any battery monomer and battery group does not reach the predetermined safe temperature.

The predetermined safe temperature is correlative to the kinds of the battery 3. For example, it can be 65 degrees centigrade.

An alarming device which is used for alarming can be positioned on the charger 1 or the battery managing device 2. The alarming device can be a buzzer. It can be avoided that the battery 3 explodes by accident.

The charger 1 works in the high voltage and current. The detecting information may be influenced by the electromagnetic interference which is generated by the charger 1. The battery managing device 2 can overcome such disadvantages and promote the nicety of the detecting information.

The principles of the preferred embodiment described herein is therefore illustrative and not restrictive, the scope of the invention being indicated in the appended claims and all variations which come within the spirit and meaning of the claims are intended be embraced therein.

What is claimed is:

1. A battery managing device, comprising:
a charger operatively coupled to a battery;
a single chip configured to determine a charging voltage and a charging current of the battery, which correlate to a residual capacitance of the battery; and
the single chip configured to control the charger to charge the battery in accordance with the determined charging voltage and charging current.

2. The battery managing device according to claim 1 further comprising:
a capacitance detecting module configured to detect a residual capacitance of the battery;
an A/D converting module; and
wherein the capacitance detecting module is operatively coupled to the A/D converting module and the A/D converting module is operatively coupled to the single chip.

3. The battery managing device according to claim 1 further comprising:
a current detecting module;
a memorizing module;
an A/D converting module; and
wherein the current detecting module is operatively coupled to the A/D converting module, the A/D converting module is operatively coupled to the single chip, and the memorizing module is operatively coupled to the single chip.

4. A method of managing battery charging using a single chip and a charger coupled to a battery, comprising:
(1) using a single chip to determine a charging voltage and a charging current of the battery, which correlate to a residual capacitance of the battery; and
(2) controlling the charger to charge the battery in accordance with the determined charging voltage and charging current.

5. The method according to claim 4, further comprising:
providing a capacitance detecting module;
providing an A/D converting module;
operatively coupling the capacitance detecting module and the A/D converting module; and
operatively coupling the A/D converting module and the single chip, wherein the residual capacitance of the battery in step (1) is detected by the capacitance detecting module.

6. The method according to claim 4, further comprising
providing a current detecting module;
providing a memorizing module;
providing an A/D converting module;
operatively coupling the current detecting module to the A/D converting module;
operatively coupling the A/D converting module to the single chip; and
operatively coupling the memorizing module to the single chip.

7. The method according to claim 6, wherein the step (1) further comprises:
(1-1) obtaining an original residual capacitance of the battery from the memorizing module, and determining an original charging voltage and an original charging current, which correlates to the original residual capacitance;
(1-2) determining present charging voltage and a present charging current, which correlate to the present residual capacitance of the battery.

8. The method according to claim 7, wherein determining the original residual capacitance in step (1-1) further comprises:
(1-1-1) obtaining an amount of the capacitance which has been drained from the battery, which is equal to an integral value of the discharging voltage and the discharging current calculated by the single chip;
(1-1-2) subtracting the amount of the capacitance which has been drained from the battery from a total capacitance of the battery to obtain the original residual capacitance;
(1-1-3) storing the original residual capacitance in the memorizer module; and
(1-1-4) obtaining the original residual capacitance from the memorizer module when the battery is charged.

9. The method according to claim 7, wherein the present residual capacitance in step (1-2) further comprises:
(1-2-1) obtaining the amount of the capacitance which has been stored in the battery when the battery is charged;
(1-2-2) obtaining the present residual capacitance by adding the original residual capacitance and the amount of the capacitance which has been stored in the battery when the battery is charged; and wherein
an amount of charge stored in the battery is equal to the integral value of the charging voltage and the charging current.

10. The method according to claim 9, further comprising:
(3) determining whether the battery is fully charged;
(3-1) controlling the charger to stop charging the battery when the battery is fully charged; and
(3-2) controlling the charger to continue charging the battery when the battery is not fully charged.

11. The method according to claim 10, further comprising:
providing a voltage detecting module;
operatively coupling the voltage detecting module to the A/D converting module; and
determining whether the voltage of a battery monomer reaches the rated voltage.

12. The method according to claim 11, further comprising:
providing a temperature detecting module;
operatively coupling the temperature detecting module to the A/D converting module; wherein the step (1) and step (2) further include:
(s-1) dividing series-wound battery monomers into a plurality of battery groups and detecting the temperature of each battery monomer and battery group;
(s-2) determining whether the temperature of one of the battery monomers and battery groups reaches the predetermined safe temperature;
(s-3) terminating charging the battery if the temperature of one of the battery monomers and battery groups reaches the predetermined safe temperature; and
(s-4) continuing to charge the battery if the temperature of any battery monomer and any battery group does not reach the predetermined safe temperature.
